(19) United States
(12) Patent Application Publication
(10) Pub. No.: US 2007/0110929 A1
(43) Pub. Date: May 17, 2007

(54) Value carrier for prepaid value units

(76) Inventor: Jan Willem Takens, Schagen (NL)

Correspondence Address: GORDON & REES LLP, 101 WEST BROADWAY, SUITE 1600, SAN DIEGO, CA, 92101, US

(21) Appl. No.: 10/519,247

(22) PCT Filed: Jun. 16, 2003
(86) PCT No.: PCT/NL03/00443

§ 371 Date: Feb. 26, 2006

(30) Foreign Application Priority Data
Jun. 28, 2002 (NL) 1020955

(51) Int. Cl. B32B 27/10

(52) U.S. Cl. 428/34.2

(57) ABSTRACT

A value carrier for prepaid value units, which value carrier comprises at least one information area on which visually readable information representing a code for prepaid value units is present, a special feature being the fact that the value carrier is sealed in an envelope. In a preferred embodiment, the envelope comprises at least two plastic foils, which are sealed together along a circumferential edge of the value carrier.

The invention relates to a value carrier for prepaid value units, which value carrier comprises at least one information area on which visually readable information representing a code for prepaid value units is present. A practical embodiment of such a value carrier is a so-called “prepaid card”. Such a “prepaid card” is for example a commercially freely available telephone card, in which case a prepaid value of a mobile telephone can be recharged by presenting the code to a relevant telephone company by telephone.

Such a value carrier in the form of a “prepaid telephone card” is known from European patent publication No. 0 896 296 (Winter Wertdruck GmbH). Said known value carrier is a plastic card the size of a credit card, on which an opaque scratch-off coating is provided on an underlying label of a transparent material that is glued or sealed (German: “aufgesiegelt”) on the information area. A buyer of said known value carrier can read the code (through the transparent label) with the naked eye by scratching off the coating with a nail. Fraudulent attempts to remove the label to find out the code in this way will result in the label being irreversibly torn or damaged, so that any fraud will be clearly distinguishable from the outside. The structure used is a “sandwich structure”, therefore, consisting of the scratch-off coating and the label, which provides protection against fraud.

British patent No. 2,252,270 (Wren-Hilton) likewise describes a “prepaid telephone card” carrying visible and invisible codes that have been placed thereon. A buyer of said card can recharge his prepaid value by presenting both codes to his telephone company by telephone. The invisible code has been rendered invisible by covering the code with an opaque scratch-off coating or with an opaque adhesive label, which permanently marks or discolours when bent or removed. As a result, a fraudulent attempt to find out the code will also be clearly distinguishable from the outside, therefore.

One drawback of a value carrier as known from European patent publication No. 0 896 296 (Winter Wertdruck GmbH), but also of the value carrier described in the aforesaid British patent specification, is that it comprises a complex anti-fraud construction, that its manufacture involves a complex manufacturing process, which renders the value carrier relatively costly and thus less attractive from an economic viewpoint.

The object of the invention is to overcome the drawbacks of the prior art, and in particular to provide a “prepaid telephone value carrier” comprising a simple anti-fraud construction.

According to the invention, a value carrier of the kind referred to in the introduction is characterized in that the value carrier is sealed in an envelope. The envelope may be made of plastic material or of paper/cardboard coated with a plastic. It is noted that the term paper is used for lighter types of paper, whilst the term cardboard is used for heavier qualities. Within the framework of the invention no limitation is intended as regards the type of material when terms such as paper, cardboard and thickness are used. Preferably, the envelope comprises at least two plastic foils, which are sealed together along a circumferential edge of the value carrier, so that a plastic seal (forming a mechanical joint) is formed along said circumferential edge. In this way an inexpensive, fraud-proof value carrier is obtained, since every attempt at fraud will leave traces in the plastic seal that can be clearly distinguished with the naked eye. After all, removal of the value carrier from the envelope of for the purpose of finding out the code will invariably result in the envelope or the plastic seal being irreversibly deformed, in particular torn or damaged. An important aspect of the invention, therefore, is that the information area on which the code is provided does not require any special anti-fraud measures itself. Preferably, the plastic seal comprises a local weakening, in particular a small notch, so that the envelope can easily be opened along said weakening for the purpose of removing the value carrier therefrom. Instead of using an envelope consisting of two separate plastic foils, it is also possible, of course, to use an envelope made of a folded (in two, for example) plastic foil, wherein foil parts are sealed together along a circumferential edge of the value carrier.

In one preferred embodiment of a value carrier according to the invention, the value carrier is sealed in an opaque envelope. In that case the code will not be visible until the value carrier has been removed from the envelope. In another preferred variants, the value carrier is sealed in a transparent envelope, and the information area is covered with an opaque material. Such a cover may be an opaque paper strip for that has been affixed to the information area, which strip must be removed from the value carrier by a buyer in order to find out the code. The adhesive may not damage the code in any way, of course.

It is noted that the present value carrier may be in the form of a “prepaid card”, in particular a “prepaid telephone card”. In another preferred embodiment, the value carrier is not a rigid “prepaid card”, but a flexible sheet that functions as a “prepaid value carrier”. Said flexible sheet is preferably a sheet of paper, which may or may not be folded, on which the code is present. The sheet of paper carrying the code printed thereon is sealed in a flexible plastic envelope in a manner similar to the manner in which refreshment tissues (commercially known as “towelettes”, which are frequently used in aeroplanes) are packaged in a flexible plastic envelope. In addition to the code, instructions for use may be printed on the sheet of paper, which may or may not be folded, possibly together with commercial information. The flexible sheet, in particular the sheet of paper, is pre-eminently suitable for use as a “prepaid telephone value carrier”.

The invention also relates to a method for manufacturing a value carrier according to the invention, which method is characterized in that
at least two plastic foils are supplied and sealed together along a circumferential edge of the value carrier, or
a folded plastic foil is supplied, and the foil parts are sealed together along a circumferential edge of the value carrier.

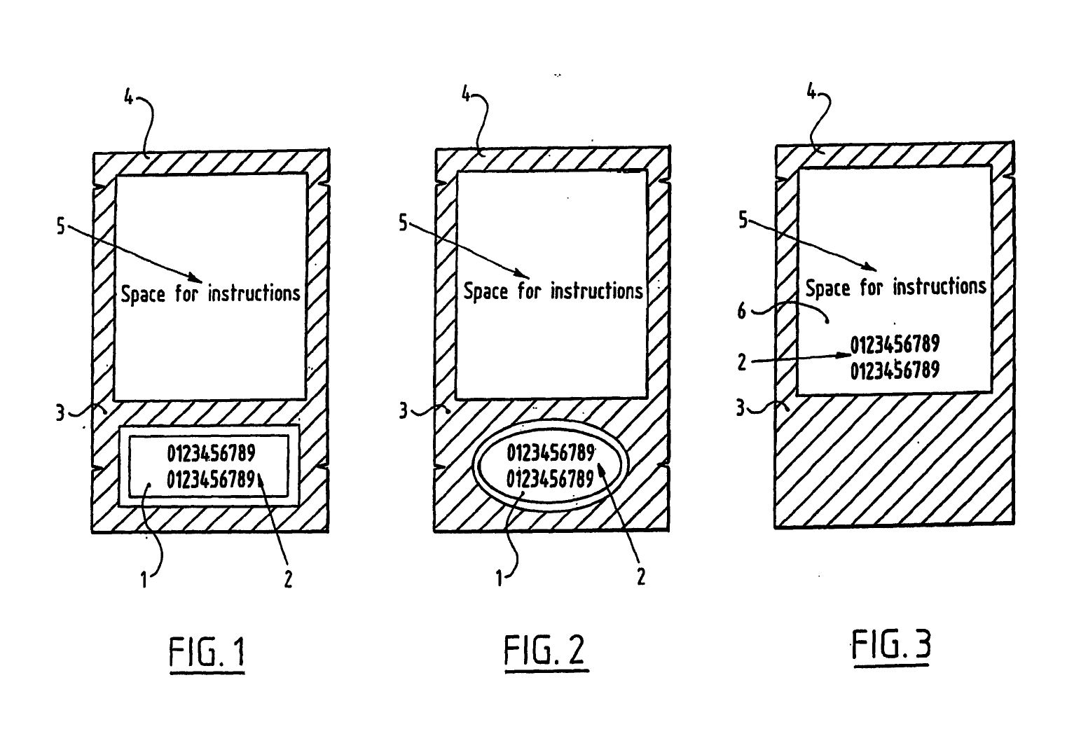

The invention will be explained in more detail hereinafter with reference to a drawing, in which FIGS. 1, 2 and 3 are schematic top plan views of a value carrier according to the invention that is present in an envelope.

FIGS. 1 and 2 show a flexible plastic envelope containing a value carrier in the form of a “prepaid telephone card”, which value carrier is an elongated (FIG. 1) or round (FIG. 2) paper/cardboard strip 1 provided with a code 2. The surface of the value carrier/strip 1 constitutes the information area in this embodiment. The code 2 represents prepaid “telephone call timing units”, e.g. to the amount of 10 euros, 20 euros etc., so that a prepaid value can be recharged accordingly upon presentation of the code 2 to a relevant telephone company.

The strip 1 is enclosed in an envelope 4 of an opaque plastic, for example a laminate of PET/PE or Polyester/PE, with the foil of the envelope 4 being sealed (i.e. melted together) along a circumferential edge of the strip 1. A plastic seal 3 is present along the circumferential edge of the strip 1, therefore, which seal will deform irreversibly upon removal of the strip 1 from the envelope 4 for reading the code 2. The envelope 4 may consist of two foils or a foil that has been folded in two.

The envelope 4 may also contain additional information 5, for example commercial information, instructions for use, a gadget and the like, which information will be separately sealed therein, however.

FIG. 3 relates to another preferred variant, in which a folded sheet of paper 6 carrying the code 2 that is printed thereon and any additional information 5 (e.g. instructions for use) is sealed (i.e. melted together) in a flexible plastic envelope 4. The sheet of paper 6 thus forms the value carrier in this case, which sheet of paper 6 is surrounded by the plastic seal 3 along its circumferential edge. Also in this case the envelope 4, which is opaque, may consist of two foils or of a foil that has been folded in two, as already explained above. Recharging of the prepaid value takes place by presenting the code 2 to the telephone company in question, to which end the sheet of paper 6 must be removed from the envelope 4. The plastic seal 3 will deform irreversibly when this is done.

It is noted that the invention is not limited to the embodiments as shown herein, but that it also extends to other variants that fall within the scope of the appended claims.

1. A value carrier for prepaid value units, which value carrier comprises at least one information area on which visually readable information representing a code for prepaid value units is present, characterized in that the value carrier is sealed in an envelope.

2. A value carrier according to claim 1, wherein the envelope is made of plastic material.

3. A value carrier according to claim 1, wherein the envelope is made of paper/cardboard coated with a plastic.

4. A value carrier according to claim 1 or 2, wherein the envelope comprises at least two plastic foils, which are sealed together along a circumferential edge of the value carrier.

5. A value carrier according to claim 1 or 2, wherein the envelope comprises a folded plastic foil, and wherein foil parts are sealed together along a circumferential edge of the value carrier.

6. A value carrier according to any one of the preceding claims 1-5, wherein the value carrier is sealed in an opaque envelope.

7. A value carrier according to any one of the preceding claims 1-5, wherein the value carrier is sealed in a transparent envelope, and wherein the information area is covered with an opaque material.

8. A value carrier according to any one of the preceding claims 1-7, wherein said value carrier is comprised of a flexible sheet, preferably a sheet of paper.

9. A value carrier according to claim 8, wherein the flexible sheet is folded.

10. A method for manufacturing a value carrier according to any one of the preceding claims 1-9, characterized in that
at least two plastic foils are supplied and sealed together along a circumferential edge of the value carrier, or
a folded plastic foil is supplied and the foil parts are sealed together along a circumferential edge of the value carrier.
